(19) United States
(12) Patent Application Publication
(10) Pub. No.: US 2007/0174717 A1
(43) Pub. Date: Jul. 26, 2007

(54) Approach for testing instruction TLB using user/application level techniques

(75) Inventors: A.R.K. Vamsee, Ongole (IN); Ravikrishnan R. Sree, Kerala (IN)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/329,205

(22) Filed: Jan. 10, 2006

(51) Int. Cl. G06F 11/00

(52) U.S. Cl. 714/39

(57) ABSTRACT

A technique for testing instruction TLB hardware involves (i) allocating a memory segment, (ii) writing instructions to pages in the memory segment for testing the instruction TLB hardware, where the instructions comprise at least one control transfer instruction, (iii) executing the instructions, and (iv) monitoring a count of events in the instruction TLB hardware occurring dependent on the executing.

### BACKGROUND

A computer system 10, as shown in FIG. 1, includes several components that are collectively used by a user to perform various functions such as, for example, preparing and generating a document with a word processor application. With the computer system 10, the user may input data to a computing portion 12 using peripheral devices such as a keyboard 14 or a mouse 16. Data may also be provided to the computing portion 12 using data storage media (e.g., a floppy disk or a CD-ROM (not shown)). The computing portion 12, using memory and other internal components, processes both internal data and data provided to the computing portion 12 by the user to generate data requested by the user. The generated data may be provided to the user via, for example, a display device 18 or a printer 20. The computing portion 12 of a computer system typically includes various components such as, for example, a power supply, disk drives, and the electrical circuitry required to perform the necessary and requested operations of the computer system.

As shown in FIG. 2, the computing portion 12 may contain a plurality of circuit boards 22, 24, 26, 28 (e.g., printed circuit boards (PCBs) or printed wiring boards (PWBs)) on which various circuit components are implemented. For example, a computing portion designed to have enhanced sound reproducing capabilities may have a circuit board dedicated to implementing circuitry that specifically operate to process data associated with the reproduction of sound.

In FIG. 2, the components of exemplary circuit board 22 are shown. A crystal oscillator 30 provides a reference of time to various integrated circuits (ICs) 32, 34, 36, 38, 40, 42 (e.g., application specific integrated circuits (ASICs), field-programmable gate arrays (FPGAs), microprocessors, logic gates) that are connected to the circuit board 22. The integrated circuits 32, 34, 36, 38, 40, 42 communicate with one another, i.e., pass data, using wires or traces of conductive material (e.g., copper (shown, but not labeled)) embedded in the circuit board 22.

In an effort to improve the performance of an integrated circuit, such as any of those described above with reference to FIG. 2, the integrated circuit often uses what is known as “virtual” memory. Virtual memory is used to present non-contiguous memory to a process (e.g., a software application) as contiguous memory. This contiguous memory is the “virtual” memory.

Virtual memory is typically organized as a collection of entries that form what is known as a “page table,” where each of the page table entries (or “pages”) represents a building block of memory. In an integrated circuit, a buffer (or cache) known as a “translation lookaside buffer” (TLB) is implemented and contains parts of a page table that translate virtual memory addresses into real (or physical) memory addresses. In general, the TLB has a fixed number of page table entries and is used to improve the speed of virtual memory address translation. Further, a TLB may contain data or instruction addresses. When containing addresses of instructions, a TLB is known as an “instruction TLB.”

A TLB is typically addressed by searching for the virtual memory address, which, if successful, results in the finding of a real (or physical) memory address.

If a virtual memory address is searched for and found in the TLB, a “hit” is said to have occurred. Otherwise, if a virtual memory address is searched for and not found in the TLB, a “miss” is said to have occurred, in which case corrective hardware and/or software action may be taken.

FIG. 3 shows a typical translation lookaside buffer 50. The translation lookaside buffer 50 is formed of a plurality of page table entries (shown, but not labeled) that each map to a particular location in a real (or physical) memory 60.

As described above, if a virtual address access is successful in the translation lookaside buffer 50, then the corresponding memory location in the real (or physical) memory 60 may be accessed and read or written to. However, if a virtual address access is not successful in the translation lookaside buffer 50, then a memory location in the real (or physical) memory 60 is not returned or otherwise made available for access.

In some cases, it may be possible for a page in a page table to not be mapped to a location in a real (or physical) memory. A “page fault” exception is thus raised when a requested page is not mapped in real (or physical) memory.

The page fault exception may be passed on to the operating system, which may then attempt to handle the page fault exception by making the required page accessible at a location in real (or physical) memory.

Causes of page fault exceptions in an instruction TLB are often related to the hardware used in implementing the instruction TLB. A typical technique used to test an instruction TLB unit runs at boot time of a computer system; thus, periodic health monitoring of the instruction TLB unit requires rebooting of the computer system.

### SUMMARY

According to one aspect of one or more embodiments of the present invention, a method of performing computer system operations comprises:

allocating a memory segment; writing instructions to pages in the memory segment for testing instruction TLB hardware, where the instructions comprise at least one control transfer instruction; executing the instructions; and monitoring a count of events in the instruction TLB hardware occurring dependent on the execution.

According to another aspect of one or more embodiments of the present invention, a computer system comprises: a processor; a memory operatively connected to the processor; and instructions residing in the memory and executable by the processor, the instructions comprising instructions to (i) allocate a memory segment, (ii) write instructions to pages in the memory segment for testing instruction TLB hardware, where the instructions comprises at least one control transfer instruction, (iii) execute the instructions, and (iv) monitor a count of events in the instruction TLB hardware occurring dependent on the execution.

According to another aspect of one or more embodiments of the present invention, a computer-readable medium having instructions recorded therein, where the instructions are for: allocating a memory segment; writing instructions to pages in the memory segment for testing instruction TLB hardware, where the instructions comprise at least one control transfer instruction; executing the instructions; and monitoring a count of events in the instruction TLB hardware occurring dependent on the executing.

Other aspects of the present invention will be apparent from the following description and the appended claims.

### BRIEF DESCRIPTION OF DRAWINGS

FIG. 1 shows a computer system.

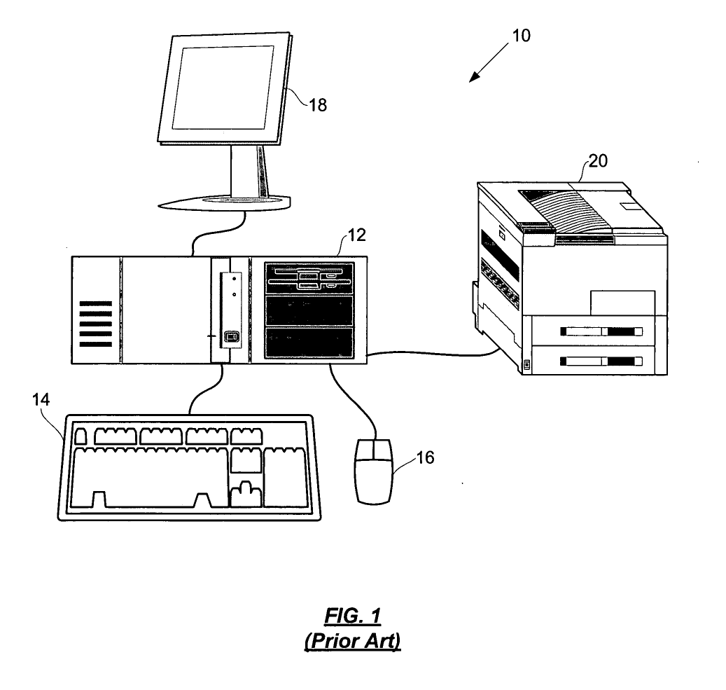

FIG. 2 shows a portion of a computer system.

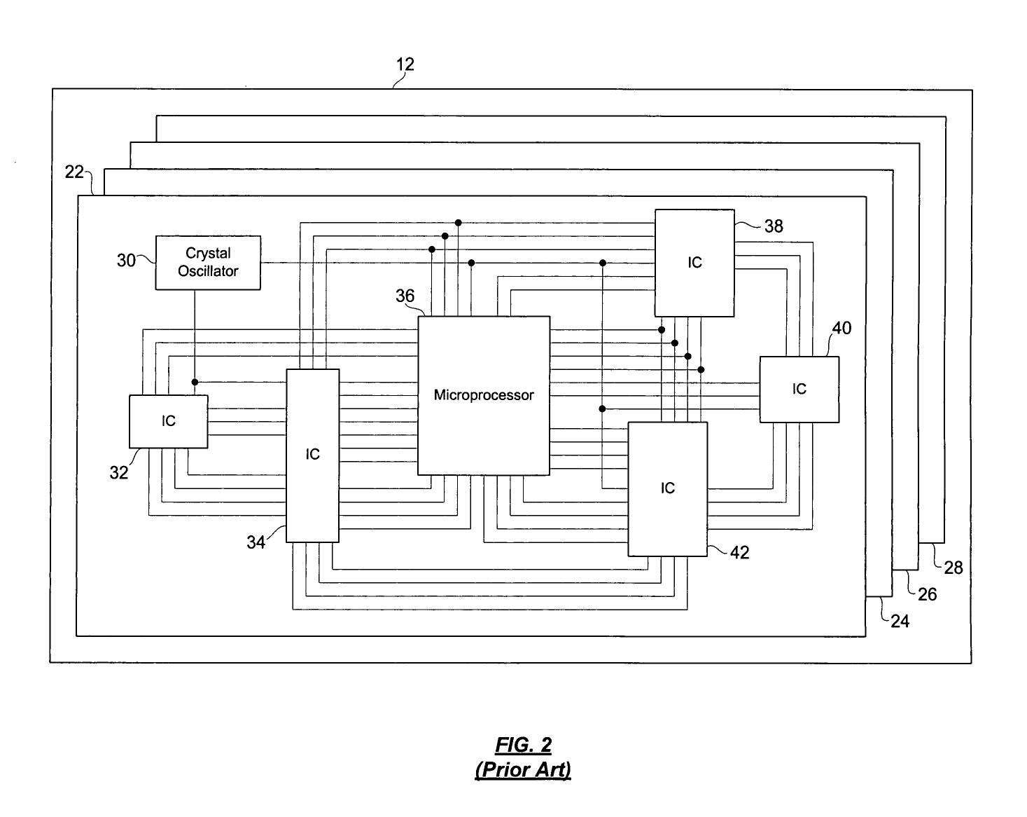

FIG. 3 shows a typical translation lookaside buffer.

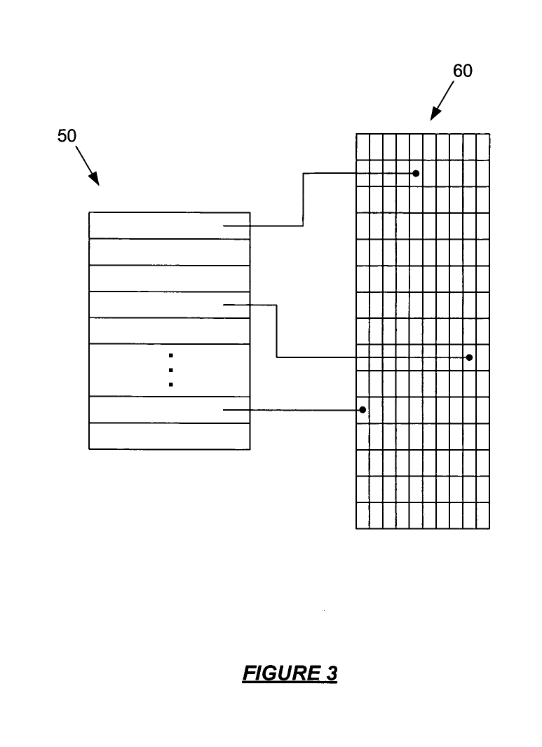

FIG. 4 shows a flow process in accordance with an embodiment of the present invention.

FIG. 5 shows a testing technique in accordance with an embodiment of the present invention.

FIG. 6 shows a testing technique in accordance with an embodiment of the present invention.

FIG. 7 shows a testing technique in accordance with an embodiment of the present invention.

FIG. 8 shows a testing technique in accordance with an embodiment of the present invention.

FIG. 9 shows a computer system in accordance with an embodiment of the present invention.

### DETAILED DESCRIPTION

Specific embodiments of the present invention will now be described in detail with reference to the accompanying figures. Like elements in the various figures are denoted by like reference numerals for consistency. Further, in the following detailed description of embodiments of the present invention, numerous specific details are set forth in order to provide a more thorough understanding of the present invention. In other instances, well-known features have not been described in detail to avoid obscuring the description of embodiments of the present invention.

Embodiments of the present invention relate to a technique for performing proactive (or reactive) diagnosis of an instruction TLB without requiring rebooting of a computer system. Generally, in one or more embodiments of the present invention, instruction TLB hardware is tested by performing functional and stress testing of hit/miss logic, one or more multiplexer(s), and tags of an instruction TLB unit. The instruction TLB hardware is verified by causing a predetermined hit/miss pattern.

In one or more embodiments of the present invention, different tests may be performed to test and verify various aspects of instruction TLB hardware. The different tests may be part of a larger algorithm used to comprehensively test the instruction TLB hardware. In one or more other embodiments of the present invention, each of the different tests may be performed individually or in particular combination with another test.

Instruction TLB tests, in accordance with one or more embodiments of the present invention, allocate memory dynamically and fill the dynamically allocated memory with control transfer instructions (e.g., jump instructions) based on a targeted fault. Control is transferred to a first location of the dynamically allocated memory, and then a sequence of jump instructions gets executed. The jump instructions cause the entries of an instruction TLB to get filled and replaced with predetermined simultaneous switching operation (SSO) patterns.

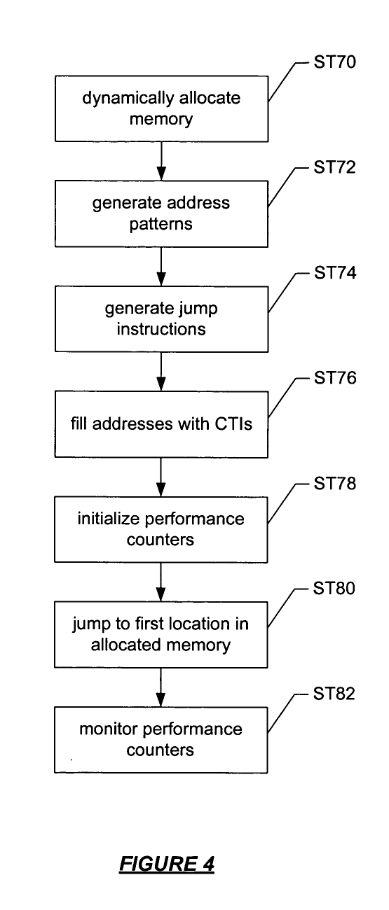

FIG. 4 shows an example of a flow process in accordance with an embodiment of the present invention. In ST70, a memory is dynamically allocated. Then, in ST72, address patterns for testing instruction TLB hardware are generated. Further, control transfer instructions (CTIs) (e.g., jump instructions) are generated ST74, and then the addresses of the dynamically allocated memory are filled with the control transfer instructions ST76. One or more performance counters used to keep count of the number of hits and misses relating to the instruction TLB hardware are also initialized ST78. The actual testing of the instruction TLB hardware occurs as control is transferred to a first location in the dynamically allocated memory ST80. As the testing occurs (further described below), the performance counters are incremented as associated events occur. The performance counters are monitored ST82, and should some deviation (e.g., 1%) from the expected number of hits and/or misses be detected by the performance counters, an instruction TLB hardware fault may be detected and corrective action may be taken.

Further, instruction TLB tests, in accordance with one or more embodiments of the present invention, may be modified for a chip-multithreaded processor accordingly. In a chip-multithreaded processor, hardware threads may share a single instruction TLB. In such a case, it may be necessary to run an idle software thread on all the hardware threads except for the one that is running or will run a test algorithm in accordance with one or more embodiments of the present invention. Those skilled in the art will note that such an implementation may help in reducing or minimizing interference between hardware threads.

Hit Tests

In accordance with one or more embodiments of the present invention, a hit test is used to verify the hit/miss logic of instruction TLB hardware. As described in general above, a dynamically allocated memory segment is filled with jump instructions and a transfer is made to a first page of the allocated memory segment. The jump instructions access previously accessed pages repeatedly to cause a large number of hits to instruction TLB hardware. Hardware performance counters are used to count the hits and misses that occurred during the hit test. Any deviation of more than some value (e.g., 1%) in the expected hit/miss ratio may suggest to a user or designer a fault in the hit/miss logic of the instruction TLB hardware. Further, those skilled in the art will note that failure of the hit test to return a location from where it is called may also suggest a possible fault in the instruction TLB hardware.

Further, in one or more embodiments of the present invention, the size of a memory dynamically allocated for a hit test may be equal to a reach of the corresponding instruction TLB. The “reach” of an instruction TLB may be defined as equal to the number of the entries in the instruction TLB multiplied by the size of each instruction page (same as a hardware page size).

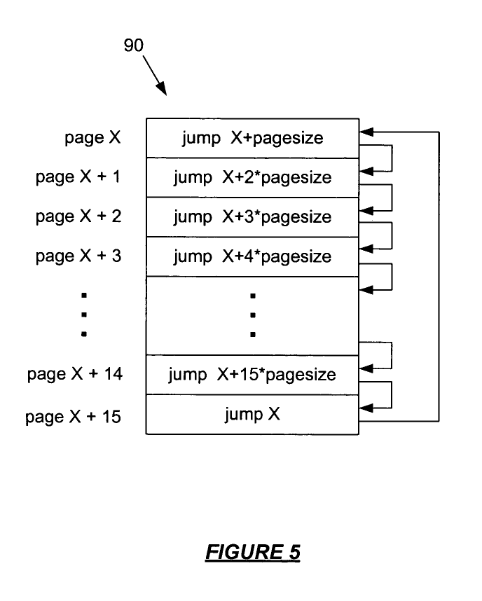

Referring to the dynamically allocated memory 90 shown in FIG. 5, in one or more embodiments of the present invention, a hit test is implemented by, for all pages in the dynamically allocated memory 90 except for the last one, writing jump instructions to the next page in the dynamically allocated memory 90. In the last page of the dynamically allocated memory 90, a jump instruction to the first page is written. As described above, because the pages in the dynamically allocated memory 90 were previously accessed and thus expected to be present in the corresponding instruction TLB, a high ratio of hits to misses is expected. Any deviation from an expected ratio may indicate fault in the hit/miss logic and/or the multiplexer and/or the tags of instruction TLB entries.

Further, in one or more embodiments of the present invention, a “hit” test may be implemented and performed using code based on pseudocode similar to that provided immediately below.

Allocate a page aligned memory of the size of itlb's reach and
lock it in memory;
Change protections of allocated memory segment to execute/write/read;
for(every location x in the allocated memory)
x:=machine instruction of “unimp” ;/*For SPARC a zero
fill can be done*/
loop_count:=0;
Let the allocated memory region address be ‘X’ and page size be ‘k’;
Y:=X;
for(all pages in the region except last page)
{

Write the following machine instructions starting from X;
if(loop_count < maxcount)
jmp X+k;
else
return:
X:=X+k;/*Go to the next page now*/

}
Write the following machine instructions to the last page

jmp Y;
loop_count++;

jmp X;

Miss Tests

In accordance with one or more embodiments of the present invention, a miss test is used to verify the hit/miss logic of instruction TLB hardware. A miss test is designed to cause a large number of misses to instruction TLB hardware.

The miss test executes instructions from pages having translation entries not present in the instruction TLB.

Further, in one or more embodiments of the present invention, the size of a memory dynamically allocated for a miss test may be at least larger than twice a reach of the instruction TLB. As described above, the “reach” of an instruction TLB may be defined as equal to the number of the entries in the instruction TLB multiplied by the size of each instruction page (same as a hardware page size).

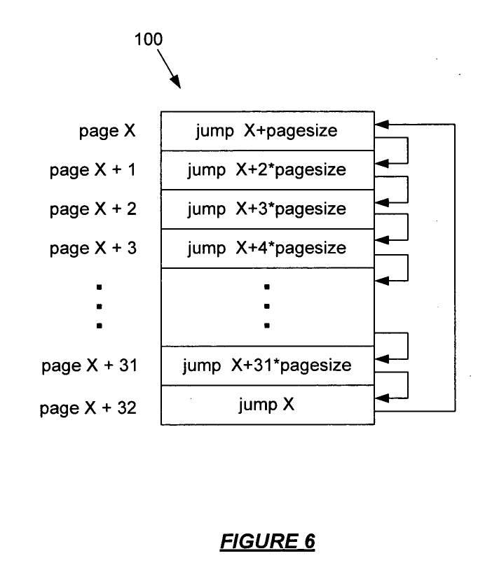

Referring to the dynamically allocated memory 100 shown in FIG. 6, in one or more embodiments of the present invention, a miss test is implemented by, for all pages in the dynamically allocated memory 100 except for the last one, writing jump instructions to the next page in the dynamically allocated memory 100. In the last page of the dynamically allocated memory 100, a jump instruction to the first page is written. As described above, because the pages in the dynamically allocated memory 100 are not present in the corresponding instruction TLB, a high ratio of misses to hits is expected. Any deviation from an expected ratio may indicate fault in the hit/miss logic and/or the multiplexer and/or the tags of instruction TLB entries.

Further, in one or more embodiments of the present invention, a “miss” test may be implemented and performed using code based on pseudocode similar to that provided immediately below.

Allocate a page aligned memory of size at least double that of itlb's reach;
lock the pages in memory;
Change protections of allocated memory segment to execute/write/read;
for(every location x in the allocated memory)
x:=machine instruction of “unimp” ;/*For SPARC a zero
fill can be done*/
loop_count:=0;
Let the allocated memory region address be ‘X’ and page size be ‘k’;
Y:=X;
for(all pages in the region except last page)
{

Write the following machine instructions starting from X;
if(loop_count < maxcount)
jmp X+k;
else
return:
X:=X+k;/*Go to the next page now*/

}
Write the following machine instructions to the last page

jmp Y;
loop_count++;

jmp X;

SSO-based Tests

In accordance with one or more embodiments of the present invention, an SSO test may be used to expose errors produces as a result of, for example, signal crosstalk and electrical noise. This is achieved with an SSO test that generates a high level of signal transitions, and, in turn, generates a lot of noise. SSO-based tests in accordance with one or more embodiments of the present invention focus on a virtual memory associated with an instruction TLB. Performance counters may be used to verify discrepancies resulting as a result of one or more SSO-based tests.

One type of SSO-based test is referred to herein as a “coupling fault” test. A coupling fault test, in accordance with one or more embodiments of the present invention, may cause transitions (high-to-low or low-to-high) to occur in entries of an instruction TLB, thereby simulating coupling faults. A coupling fault may be defined as a cell becoming low or high, either when a read/write is made to a neighboring word or when a high-to-low or low-to-high transition occurs in a neighboring word.

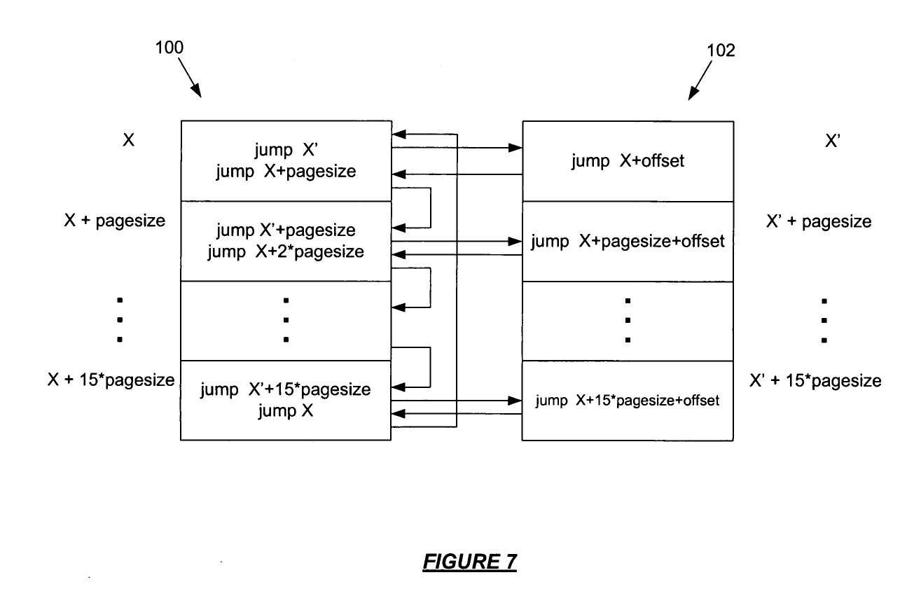

Referring to FIG. 7, in one or more embodiments of the present invention, a coupling fault test results in the dynamic allocation of two memory regions 100, 102. The virtual addresses at which the memory regions 100, 102 are mapped/located may be complements of each other. A “complement” of an address may be generated by replacing every ‘1’ bit with a ‘0’ bit and every ‘0’ bit with a ‘1’ bit. In one or more embodiments of the present invention, the sizes of memory regions allocated should be at least equal to the reach of the instruction TLB. As described above, the “reach” of an instruction TLB may be defined as equal to the number of the entries in the instruction TLB multiplied by the size of each instruction page (same as a hardware page size).

A first jump instruction is written to each page in memory 100 for causing control to transfer to a corresponding page in memory 102. A jump instruction in the corresponding page in memory 102 causes control to return back to the corresponding page in memory 100. Except for the last page of memory 100, a second jump instruction is written in each page of memory 100 to cause control to transfer to a next page in memory 100. The last page in memory 100 is written with a second jump instruction that causes control to transfer back to the first page in memory 100. As described above, the frequent changes in control may introduce complement patterns in adjacent lines of the instruction TLB, and, in turn, expose errors occurring as a result of, for example, signal crosstalk and electrical noise.

In one or more embodiments of the present invention, failure to reach the first page of the memory region 100 or any operating before the last system notified failure (e.g., a SIGSEGV/SIGILL signal sent to the process) may indicate an instruction TLB fault. In such a case, the test may then be repeated by interchanging memory regions 100, 102. i.e., starting from memory region 102 instead of from memory region 100 after rewriting instruction sequences. Those skilled in the art will note that such a technique may ensure the verification of all possible effects of “high-to-low” and “low-to-high” transitions in neighboring words.

Further, in one or more embodiments of the present invention, a “coupling fault” test may be implemented and performed using code based on pseudocode similar to that provided immediately below.

Find the maximum allocatable memory A;
Generate a random number X and let its complement be ˜X;
Check both X and ˜X can be used as valid addresses;
If valid, memory map two regions starting from X and
(˜X − A/2) each of size
A/2 with pagesize k;
lock the pages in memory;
Change protections of allocated memory segment to execute/write/read;
for(every location x in the allocated memory)

x:=machine instruction of “unimp” ;/*For SPARC a zero fill can be

done*/

N:=0;
for(all pages in X except last page)
{

Write the following machine instructions starting from X+(N*k);
jmp˜X−(N*k);
jmp X+(N+1)k;
N:=N+1;

})
Write the following machine instructions to the last page of X

jmp˜X−(N*k);
return:

N:=0;
for(all pages in ˜X)
{

Write the following machine instructions starting from ˜X −(N*k);
jmp X+(N*k)+offset;/*offset = size of one instruction e.g. 8 bytes for

N:=N+1;
}

jmp X;

Another type of SSO-based test is referred to herein as a “transition and stuck-at-fault” test. A transition and stuck-at-fault test causes entries to be replaced and filled in a predetermined sequence to expose transition and stuck-at-faults. A transition fault may be defined as a failure of a cell to transition from low to high or from high to low. A “stuck-at-fault” may be defined as a cell that is “stuck” high or low.

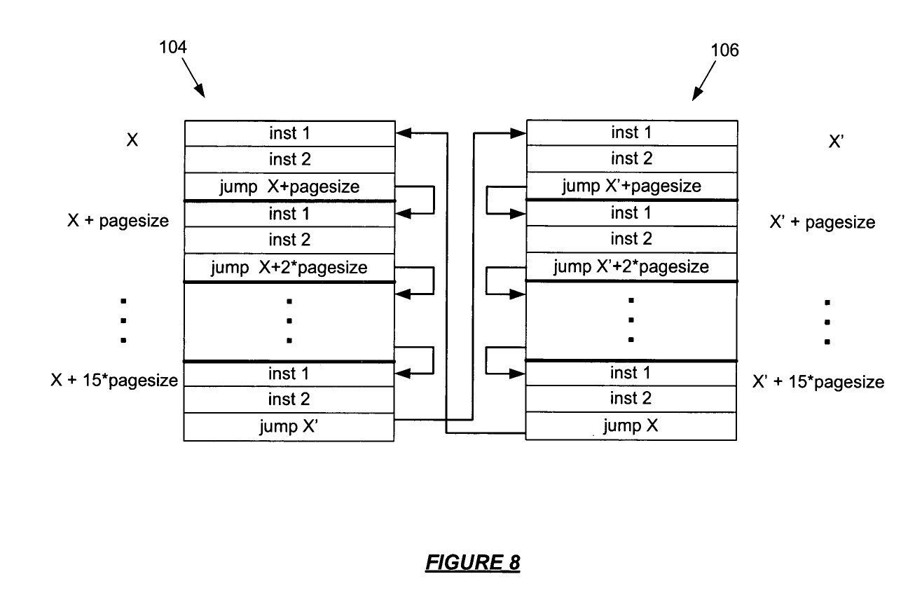

Referring to FIG. 8, in accordance with one or more embodiments of the present invention, a transition and stuck-at-fault test results in the dynamic allocation of two memory regions 104, 106. The virtual addresses at which the memory regions 104, 106 are mapped/located may be complements of each other.

A “complement” of an address may be generated by replacing every ‘1’ bit with a ‘0’ bit and every ‘0’ bit with a ‘1’ bit. In one or more embodiments of the present invention, the sizes of memory regions allocated should be at least equal to the reach of the instruction TLB. As described above, the “reach” of an instruction TLB may be defined as equal to the number of the entries in the instruction TLB multiplied by the size of each instruction page (same as a hardware page size).

In each page of memory region 104, a sequence of instructions are written followed by a jump instruction to a next page, except for in the last page, where the jump instruction transfers control to a first page in memory region 106. Memory region 106 is similarly arranged as shown in FIG. 8, except for that in the last page of memory region 106, the jump instruction transfers control to the first page in memory region 104. As described above, a transition and stuck-at-fault test is designed to ensure that sequences of instructions are properly handled by instruction TLB hardware. Should an error occur during the flow shown in FIG. 8, a fault in the instruction TLB hardware may have indicated.

In one or more embodiments of the present invention, failure to reach the first page of the memory region 104 or any operating before the last system notified failure (e.g., a SIGSEGV/SIGILL signal sent to the process) may indicate an instruction TLB fault. In such a case, the test may then be repeated by interchanging memory regions 104, 106. i.e., starting from memory region 106 instead of from memory region 104 after rewriting instruction sequences. Those skilled in the art will note that such a technique may aid in verifying that all “high-to-low” and “low-to-high” transitions within a given instruction TLB entry are fault-free.

Further, in one or more embodiments of the present invention, a “stuck-at-fault” test may be implemented and performed using code based on pseudocode similar to that provided immediately below.

loopcount:=0;

START:

Generate a random number X and let its complement be ˜X;
Check both X and ˜X can be used as valid addresses;
If valid, memory map two regions starting from X and
(˜X − A/2) each of size
equal to ITLB) reach with pagesize k;
lock the pages in memory;
Change protections of allocated memory segment to execute/write/read;
for(every location x in the allocated memory)

x:=machine instruction of “unimp” ;/*For SPARC a zero fill can be

done*/

N:=0;
for(all pages in X except last page)
{

Write the following machine instructions starting from X+(N*k);
jmp X+(N+1)k:
N:=N+1;

}
Write the following machine instructions to the last page of X

jmp ˜X;

N:=0;
for(all pages in ˜X except last page)
{

Write the following machine instructions starting from ˜X − (N*k);
nop;
nop;
nop;
nop;
jmp ˜X−((N+1)*k);/* offset = size of one instructione.g. 8 bytes for

SPARC V9*/

N:=N+1;

}
Write the following machine instructions to the last page of X

nop;
nop;
nop;
nop;
return;

jmp X;
if (++loopcount < Maxtries)

goto START;

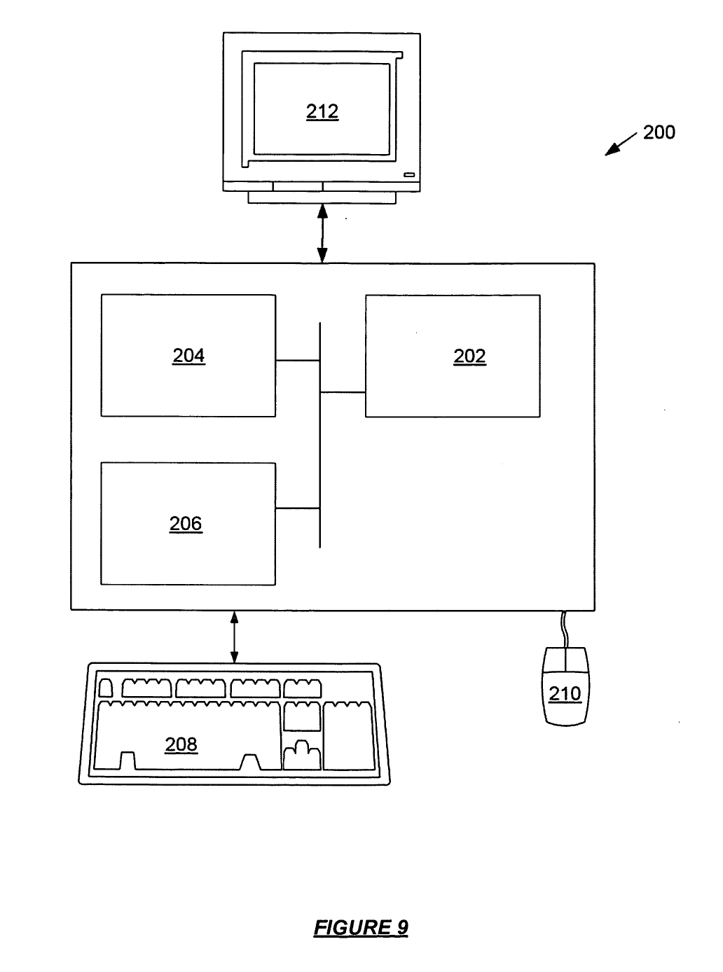

Further, one or more embodiments of the present invention may be associated with virtually any type of computer system, including multiprocessor and multithreaded uniprocessor systems, regardless of the platform being used. For example, as shown in FIG. 9, a networked computer system 200 includes at least one processor 202, associated memory 204, a storage device 206, and numerous other elements (not shown) and functionalities typical of modern computer systems. The networked computer system 200 may also include input means, such as a keyboard 208 and a mouse 210, and output means, such as a monitor 212. The networked computer system 200 is connected to a local area network (LAN) or a wide area network (e.g., the Internet) via a network interface connection (not shown). Those skilled in the art will appreciate that these input and output means may take other forms. Further, those skilled in the art will appreciate that one or more elements of the networked computer system 200 may be remotely located and connected to the other elements over a network. Further, software instructions to perform one or more embodiments of the present invention may be stored on a computer readable medium such as a compact disc (CD), a diskette, a tape, a file, a hard drive, or any other computer-readable storage device.

Advantages of the present invention may include one or more of the following. In one or more embodiments of the present invention, instruction TLB hardware may be tested without having to shut down or reboot a computer system.

In one or more embodiments of the present invention, instruction TLB hardware may be dynamically tested for faults.

In one or more embodiments of the present invention, instruction TLB hardware testing may be performed to test the hit/miss logic, multiplexer logic, and/or tag portions of all entries of the instruction TLB hardware.

In one or more embodiments of the present invention, a technique for testing instruction TLB hardware may take a relatively short period of time due to the relatively small number of instructions that are executed.

In one or more embodiments of the present invention, a technique for testing instruction TLB hardware may not require read/write verify logic as a fault in the instruction TLB hardware may manifest as a failure to return the expected location and/or as an operating system generated signal.

In one or more embodiments of the present invention, a technique for testing instruction TLB hardware may be portable among two or more hardware platforms due to the relatively low dependency of the instruction set on the underlying hardware.

In one or more embodiments of the present invention, a technique for testing instruction TLB hardware may be scalable with the number of entries in an instruction TLB and associativity of the instruction TLB.

In one or more embodiments of the present invention, a technique for testing instruction TLB hardware may not be dependent on operating system activity.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of performing computer system operations, comprising:
allocating a memory segment;
writing instructions to pages in the memory segment for testing instruction TLB hardware, the instructions comprising at least one control transfer instruction;
executing the instructions; and
monitoring a count of events in the instruction TLB hardware occurring dependent on the execution.

2. The method of claim 1, further comprising:
dynamically allocating the memory segment.

3. The method of claim 1, wherein the at least one control transfer instruction is a jump instruction.

4. The method of claim 1, further comprising:
detecting a fault in the instruction TLB hardware based on the count.

5. The method of claim 1, further comprising:
initializing the count prior to the executing.

6. The method of claim 1, the writing comprising:
writing a first jump instruction in a first page of the memory segment, wherein the first jump instruction references a next page in the memory segment; and
writing another jump instruction in a last page of the memory segment, wherein the another jump instruction references the first page.

7. The method of claim 1, wherein a majority of pages of the memory segment were one of previously accessed and not previously accessed using the instruction TLB hardware.

8. The method of claim 1, further comprising:
allocating another memory segment.

9. The method of claim 8, the writing comprising:
writing a first jump instruction in a first page of the memory segment, wherein the first jump instruction references a page of the another memory segment;
writing a second jump instruction in the page of the another memory segment, wherein the second jump instruction references the first page of the memory segment;
writing a third jump instruction in the first page of the memory segment, wherein the third jump instruction references a next page of the memory segment; and
writing a fourth jump instruction in a last page of the memory segment, wherein the fourth jump instruction references the first page of the memory segment.

10. The method of claim 8, the writing comprising:
writing a first jump instruction in a first page of the memory segment, wherein the first jump instruction references a next page of the memory segment; and
writing a second jump instruction in a last page of the memory segment, wherein the second jump instruction references a page of the another memory segment.

11. A computer system, comprising:
a processor;
a memory operatively connected to the processor; and
instructions residing in the memory and executable by the processor, the instructions comprising instructions to:
allocate a memory segment,
write instructions to pages in the memory segment for testing instruction TLB hardware, the instructions comprising at least one control transfer instruction,
execute the instructions, and
monitor a count of events in the instruction TLB hardware occurring dependent on the execution.

12. The computer system of claim 11, further comprising instructions to:
indicate a fault in the instruction TLB hardware based on the count.

13. The computer system of claim 11, the instructions to write comprising instructions to:
write a first jump instruction in a first page of the memory segment, wherein the first jump instruction references a next page in the memory segment; and
write another jump instruction in a last page of the memory segment, wherein the another jump instruction references the first page.

14. The computer system of claim 11, further comprising instructions to:
allocate another memory segment.

15. The computer system of claim 14, the instructions to write comprising instructions to:
write a first jump instruction in a first page of the memory segment, wherein the first jump instruction references a page of the another memory segment;
write a second jump instruction in the page of the another memory segment, wherein the second jump instruction references the first page of the memory segment;
write a third jump instruction in the first page of the memory segment, wherein the third jump instruction references a next page of the memory segment; and
write a fourth jump instruction in a last page of the memory segment, wherein the fourth jump instruction references the first page of the memory segment.

16. The computer system of claim 14, the instructions to write comprising instructions to:
write a first jump instruction in a first page of the memory segment, wherein the first jump instruction references a next page of the memory segment; and
write a second jump instruction in a last page of the memory segment, wherein the second jump instruction references a page of the another memory segment.

17. A computer-readable medium having instructions recorded therein, the instructions for:
allocating a memory segment;
writing instructions to pages in the memory segment for testing instruction TLB hardware, the instructions comprising at least one control transfer instruction;
executing the instructions; and
monitoring a count of events in the instruction TLB hardware occurring dependent on the executing.

18. The computer-readable medium of claim 17, the instructions for writing comprising instructions for:
writing a first jump instruction in a first page of the memory segment, wherein the first jump instruction references a next page in the memory segment; and
writing another jump instruction in a last page of the memory segment, wherein the another jump instruction references the first page.

19. The computer-readable medium of claim 17, further comprising instructions for:
allocating another memory segment;
writing a first jump instruction in a first page of the memory segment, wherein the first jump instruction references a page of the another memory segment;
writing a second jump instruction in the page of the another memory segment, wherein the second jump instruction references the first page of the memory segment;
writing a third jump instruction in the first page of the memory segment, wherein the third jump instruction references a next page of the memory segment; and
writing a fourth jump instruction in a last page of the memory segment, wherein the fourth jump instruction references the first page of the memory segment.

20. The computer-readable medium of claim 17, further comprising instructions for:
allocating another memory segment;
writing a first jump instruction in a first page of the memory segment, wherein the first jump instruction references a next page of the memory segment; and
writing a second jump instruction in a last page of the memory segment, wherein the second jump instruction references a page of the another memory segment.
